(19) United States
(12) Patent Application Publication
(10) Pub. No.: US 2007/0162961 A1
(43) Pub. Date: Jul. 12, 2007

(54) IDENTIFICATION AUTHENTICATION METHODS AND SYSTEMS

(76) Inventors: KELVIN TARRANCE, BLOOMINGTON, IL (US); DANIEL ALMAN, FORT WORTH, TX (US)

Correspondence Address: TROUTMAN SANDERS LLP, 600 PEACHTREE STREET , NE, ATLANTA, GA, 30308, US

(21) Appl. No.: 11/276,358

(22) Filed: Feb. 26, 2006

Related U.S. Application Data
(60) Provisional application No. 60/656,843, filed on Feb. 25, 2005.

(51) Int. Cl. H04L 9/32

(52) U.S. Cl. 726/5

(57) ABSTRACT

Identification authentication methods and systems are provided. In accordance with some embodiments, a user can verify or authenticate an item to ensure if the item is authentic by utilizing a security token. For example, a user can authenticate a website to determine if the website is authentic by providing information to decrypt a security token, and the user can determine if the website is authentic by reviewing the decrypted security token. An authentication method between a user and a service provider can comprise generating a security token, presenting the security token to a user, decrypting the security token, and receiving user information to authenticate a user. The security token can based at least partially on user information, and can comprise encrypted token information. Decrypting the security token can occur dynamically in real time so the token information appears enabling a user to authenticate a service provider. Other embodiments are also claimed and described.

### CROSS-REFERENCE TO RELATED APPLICATION

This application claims the benefit of U.S. Provisional Application No. 60/656,843 filed 25 Feb. 2005, which is incorporated herein by reference in its entirety as if fully set forth below.

### TECHNICAL FIELD

The various embodiments of the present invention relate generally to internet and computer network security, and more particularly, to devices, methods, and systems that provide identification authentication between users and devices in a computer network.

### BACKGROUND

Proliferation of the Internet has brought on unprecedented access to sales and services. Unfortunately, however, the Internet's growth has also created new opportunities for scam artists and others who seek to use fraudulent business schemes for ill-gotten gains. In the traditional business world, people do not hand over personal and financial information to strangers without verification. While real world verification can be easily accomplished due to personal, face-to-face transactions, verifying identities in the virtual world remains challenging.

A key issue with virtual authentication is identifying and verifying the identity of who someone is conducting business over a network (e.g., Internet). In the traditional brick and mortar world, it is easy to know whom you are dealing with because consumers have public interaction. On virtual networks it is not so easy. Just about anyone with the right tools can create fake authentication screens or websites that look just like the real ones. Thus, determining who someone is over a network and determining to trust someone are important issues that should be resolved for any consumers conducting business over a network, such as the Internet. Accordingly, businesses and service providers should strive to create safe virtual transactions to instill customer and consumer confidence thereby increasing revenues, profits, and goodwill.

A known method of identifying a user is the traditional user-name authentication method. This method is a one-way authentication method. Using an Internet website as an example, by entering the correct username-password combination, the website can verify the identity of a visitor but the visitor has no way of knowing the identity of the system. Many online scam artists use fake websites made to look like a real business's website. For example, a scam artist may replicate a bank's website to obtain a banking client's bank account information. Scammers can even fake other financial websites, such as PayPal®. Fake websites can last as long as six days before being detected and shut down. When unsuspecting users login to a fake website, the scammers can steal their username and password, and use this information to gain access to legitimate online accounts.

Many vendors are attempting to solve the virtual identification problem using different technologies. Some of these technologies include SiteKey, Token Two Factor Authentication, Phone confirmation, and SSL Web certificates. PassMark Security's SiteKey technology discussed in U.S. Patent Application Publication Numbers 2004/0168083, 2005/0177750, 2005/0268100, and 2005/0268101 utilizes a static picture and cookies for authentication. Each of these published patent applications is hereby incorporated by reference as if fully set forth herein.

While these conventional technologies serve their respective purposes, they do have associated drawbacks. For example, one such drawback includes that static identification methods and cookies are utilized. Static identification, however, once compromised, can be use to deceive a user, thus defeating the purpose of verifying identification. In addition, static identification is less desirable because static authentication information provided in an unencrypted communication, such as email, can be sniffed or seen using network tools. Similarly, cookies are transparent and can be easily hacked by scam artists. For example, cookies are vulnerable, transparent to users, and can be abused by scammers. Also, Token Two Factor Authentication users must carry around a token to retrieve a one-time password, which can cause problems if people lose the token. Further, maintenance and installation costs associated with the Token Two Factor Authentication are high. Phone confirmation users must always have access to a phone, and phone access can be challenging and inconvenient at times. As for SSL Certificates, they are not desirable because they are difficult to manage, are expensive to purchase from third parties, scale poorly, have secure storage issues, and also have key revocation issues.

Accordingly, identification authentication methods and systems that overcome the above discussed drawbacks are needed in the art. Embodiments of the present invention are directed to methods and systems that provide identification authentication abilities for virtual network users to assist users and network hosts to prevent fraudulent schemes. Embodiments of the present invention also provide methods and systems enabling identification authentication between two parties so that each party can verify the identity of the other party before exchanging confidential information. It is to the provision of identification authentication and verification methods, devices, and systems that the various embodiments of the present invention are directed.

### BRIEF SUMMARY

The various embodiments of the present invention provide a straightforward identification authentication technology that leverages existing infrastructure. Embodiments of the present invention provide technology that builds upon and improves the known conventional username-password method, and adds a token confirmation for users to verify positively the identity of a service provider. Indeed, embodiments of the present invention enable customers to be assured of the authenticity of a communication including, but not limited to, a network device, a web service, a website, a text message, or an email.

Embodiments of the present invention utilize various features to provide identification authentication methods and systems. For example, some embodiments utilize a token, such as a 128 bit AES encrypted token, and cookies are not preferably utilized. Embodiments of the present invention can be implemented with minimal costs and can be utilized with various user environments, such as web services, communications, networked devices, or appliances. Preferably, a token used in some embodiments of the present invention is a dynamic token enabling authentication to occur without using static information. A token can contain any information unique to a user. For example, when authenticating, a token can contain information such as date, time, mutually agreed upon information, location information, or the like. In addition, embodiments of the present invention can be utilized as a stand alone identification verification program or can be used in conjunction with the other authentication technologies. In yet other embodiments, the present invention can be implemented as a hosted solution or operated solely by a service provider.

Broadly described, an identification authentication system can comprise a first device and a second device. The first and second devices can be a computing device. The first device can be networked to the second device so that the first device can communicate with the second device. The first device can receive a first set of user information and communicate the first set of user information to the second device. The first set of user information can include a login name. The second device can generate a security token in response to the first set of user information and provide the security token to the first device for user review. The security token can comprising token information. Token information can include information unique to a user or a consumer. The first device can receive a second set of user information so that a user can dynamically decrypt the security token in substantially real time to access the token information to authenticate the second device. The second set of user information can include an encryption key known by a consumer and previously agreed upon by a service provider and a consumer.

The system can also include a third device. The third device can be in communication with the second device. The third device being can provide the token generator with the unique user information. The unique user information is preferably associated with the first set of user information, and a service provider and consumer may have previously agreed upon the unique user information.

The system can also comprise a token generator. The token generator can generate the security token based on the first set of user information. The token generator can receive unique user information from a database based upon the first set of user information, and the token generator can encrypts the unique user information and can provide the encrypted unique user information as at least part of the security token. The token generator can utilizes a symmetric encryption algorithm to encrypt the unique user information. Alternatively, many other encryption algorithms may be utilized.

The security token can also have additional features. The security token can comprise at least one of a visual component and an audio component. Visual components can include animated pixels or flash-type animation. The security token can also comprise hypertext markup language (HTML) code that upon receipt of at least a portion of the second set of user information is adapted to animate the security token and dynamically reveal the token information. The security token can comprise a plurality of pixel elements and the first device can be adapted to dynamically adjust one or more pixels of the security token upon receiving at least a portion of the second set of user information. The decrypted token information can be formatted so that a machine can not read the decrypted token information.

In another embodiment, an identification authentication method can comprise generating an encrypted token comprising user information; receiving information from a user to access the user information from the encrypted token; and using the received information to decrypt the encrypted token in substantially real time so that a user can authenticate an identity associated with a communication. The method can further comprise presenting the token to a user so that a user receives the encrypted token prior to using the received information to decrypt the encrypted token. Generating the token can comprise encrypting unique user information with a symmetric encryption algorithm. The communication can include at least one of an electronic mail message, a video mail message, a website file, a network device query, a network query, a text message, and a digital file.

The method can also have additional features. For example, the received information may only decrypt the encrypted token if the received information matches a previously determined encryption key such that the encrypted token is not partially decrypted. Also, displaying the encrypted token can include displaying the token as a block of HTML code. The HTML code block can have a plurality of pixel elements adapted to dynamically change to reveal the token information when the security token is decrypted.

In yet another embodiment of the present invention, the present invention can be implemented as an authentication method between a user and a service provider. The method can comprise generating a security token based at least partially on user information, presenting the security token to a user, and decrypting the security token. The security token can comprise encrypted token information. Decrypting the security token can occur in substantially real time so that during decryption the token information is dynamically presented to a user so that a user utilizes the decrypted security token to authenticate a service provider. The method can also include receiving information from a user so that a service provider can authenticate the user.

The method embodiment can also include additional features. For example, generating the security token can comprise encrypting the security token with a symmetric encryption algorithm. Also, presenting the security token can comprises displaying the security token in at least one of a visual format and an audio format. Decrypting the security token in substantially real time can comprise utilizing information provided by a user to animate the security token so that the encrypted token information is dynamically decrypted.

Other aspects and features of embodiments of the present invention will become apparent to those of ordinary skill in the art, upon review of the following description of specific, exemplary embodiments of the present invention in conjunction with the accompanying figures.

### BRIEF DESCRIPTION OF DRAWINGS

FIG. 1 illustrates a sample user interface that enables a user to access a website in accordance with some embodiments of the present invention.

FIG. 2 illustrates a sample user interface after a user has provided a User ID and a User Passphrase in accordance with some embodiments of the present invention.

FIG. 3 illustrates a sample user interface after a user submits a User ID and a User Passphrase to initiate generation of a token in accordance with some embodiments of the present invention.

FIG. 4 illustrates a sample user interface which enables generation of a token in real time as a user provides a User Passphrase in accordance with some embodiments of the present invention.

FIG. 5 illustrates a sample user interface which provides a decrypted token after a user provides a User Passphrase so that a user can authenticate a website in accordance with some embodiments of the present invention.

FIG. 6 illustrates a sample user interface which enables a user to access a website after the user has authenticated the website with a token in accordance with some embodiments of the present invention.

FIG. 7 illustrates a sample user interface showing successful identification authentication between a user and a website in accordance with some embodiments of the present invention.

FIG. 8 illustrates a logic flow diagram showing an identification authentication method according to some embodiments of the present invention.

FIG. 9 illustrates a sample communication enabling a recipient and a sender to verify each other's identity in accordance with some embodiments of the present invention.

FIG. 10 illustrates a computer network system utilizing an embodiment of the present invention to provide identification authentication for users.

### DETAILED DESCRIPTION OF PREFERRED AND ALTERNATIVE EMBODIMENTS

The Internet age has opened up a new sales and service channel to all businesses. More than ever, companies are opening their virtual doors to the Internet and doing more business transactions online, through computer networks, and by various forms of electronic mail. Indeed, service providers and consumers exchange personal, financial, and confidential information over the Internet at an increasing rate.

Unfortunately scammers are also looking to profit from the Internet. The Federal Trade Commission's (FTC) Consumer Sentinel indicates that approximately forty-two percent of fraud complaints filed were Identity Theft claims. Phishing, the latest online, internet based scam, uses forged emails and fake websites to trick people into disclosing personal financial information, such as credit card numbers, social security numbers, bank account numbers, passwords, and the like. Once having personal financial information, fraudsters can use it to conduct illicit financial transactions harming innocent victims. The Federal Bureau of Investigation (FBI) declared Phishing as the hottest and the most troubling new Internet scam.

The various embodiments of the present invention provide identification authentication methods, devices, and systems to address the above and other problems. The various embodiments of the present invention build upon and enhance the conventional username-password combination used by virtually all computer users. The various embodiments of the present invention enable generation of a token comprising token information and provide a token confirmation enabling users to verify the identity of a service provider, such as a website operator. Users and customers can also utilize the token confirmation to determine the authenticity of a communication which gives users and customer confidence in dealing with a service provider.

The various embodiments of the present invention can be utilized with many different platforms. Users can authenticate a service provider's website, email, text message, network device, any type of digital file, or private and public computer networks using embodiments of the present invention. For example, a user receiving an email from a service provider can utilize embodiments of the present invention to determine if the received email originated from the service provider, thus authenticating the email. In addition, embodiments of the present invention enable parties to quickly authenticate a device or other network components associated with the users prior to the users exchanging personal information.

User experience is generally critical to the success of any business entity. When a service provider's users or consumers do not feel safe, there can be many negative effects for the service provider, users, and consumers. With Identity Thieves ranking very high in fraudulent crimes, positive identification has been and still is paramount when users and consumers interact with service providers. When service providers utilize embodiments of the present invention, service providers demonstrate that user safety is important to ensure that a service provider's users and customers can verify the identity of the service provider for security. The various embodiments of the present invention provide a straightforward identification authentication technology enabling users to determine if they are really working with their true service provider. Generally described, verification according to embodiments of the present invention can occur in two fashions.

The first fashion is an active username identification process. The active username identification process can verify the authenticity of a website or other environments requiring an active login process. An active login process usually requires a user to enter a username and password to gain access. Some embodiments of the active username identification process according to the present invention can include receiving a user name from a user, providing a token to the user based on the user name, receiving a passphrase from the user to access token information in the token, providing the token information to a user as a token confirmation so the user can verify the service provider's identity, and receiving a password from the user so the service provider can verify the user's identity. In some embodiments of the present invention, the passphrase can be the same as the password and in other embodiments, the passphrase can be different than the password.

The second fashion is a passive username identification process. The passive username identification process can be used to authenticate communications between senders and recipients, such as one-way communications. Sample one-way communications include emails, instant messages, web services, text messages, audio grams, video grams, video mails, picture grams, electronic digital files, or the like. Because the sender of a one-way communication knows the recipient of the one-way communication, the sender can thus provide a token to the recipient in concert with the one-way communication. Accordingly, once the recipient receives the one-way communication and associated token, the recipient can provide information (a password and/or passphrase) to access token information associated with the token. Upon successfully entering the password and receipt of appropriate token information as a token confirmation, the user can verify the identity of the sender of the one-way communication.

As will be discussed in more detail below, token generation and token display are features utilized in various embodiments of the invention. A service provider can generate security tokens using information known about a user and provide the generated token to a user. The generated token can comprise token information that, once provided to the user, enables the user to verify the service provider's identity. Preferably, the token is encrypted using an encryption process or algorithm. The encryption algorithm can be the Advanced Encryption Standard (AES) that uses a 128-bit encryption key. Many other encryption algorithms and key lengths can be utilized such as 192-bit and 256-bit keys. As those skilled in the art will understand, AES is a symmetric key encryption technique recently adopted by the National Security Agency (NSA). Once the user receives a token encrypted with token information, the user can decrypt the token with a password (or passphrase). If the decrypted token displays previously agreed upon information known to the user, the user can then verify the identity of the service provider before exchanging information with the service provider.

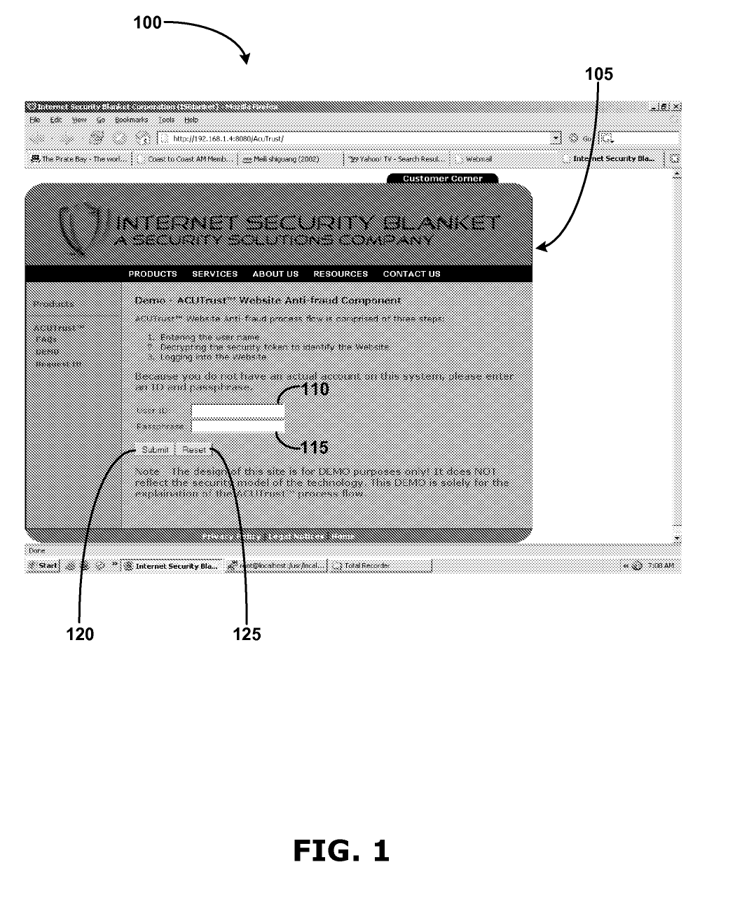

Referring now to the figures, wherein like reference numerals represent like features throughout the several views, FIG. 1 illustrates a sample user interface 100 that enables a user to access a website 105 in accordance with some embodiments of the present invention. It should be understood that the website 105 embodiment is an exemplary embodiment of the present invention and that other embodiments exist in which embodiments of the present invention can be implemented.

In the website 105 embodiment of the present invention, a service provider provides the website 105 to a user. The user can utilize the active username identification process as discussed above to access the website 105 and verify the identity of the service provider hosting the website 105. Prior to the user accessing the website 105, the user and the service provider preferably agree on identification information. For example, when implementing embodiments of the present invention, service providers may utilize previously collected identification information from users. Alternatively, a user can provide identification information to a service provider when accessing the website 105. Identification information preferably includes information unique to a user, and can include one or more unique pieces of information associated with a user. Sample unique user identification includes, but is not limited to, mother's maiden name, pin numbers, birth date, account number, social security number, zip code, address, answer to a challenge question, or the like.

Implementation of embodiments of the present invention can occur according to several different features. For example, a service provider may desire to utilize some embodiments of the present invention on its own hardware, or a service provider may choose to have an entity (or third party), such as Internet Security Blanket Corporation, to host embodiments of the present invention on hardware not owned or managed by the service provider. Those skilled in the art will understand that reference to hardware includes computing devices, private and public networks, and computer file servers. Thus, some embodiments of the present invention can be implemented with software while others can be implemented a combination of hardware and software. Accordingly, users of some embodiments of the present invention may only need to provide a user interface and a third party can provide the identification authentication methods and systems according to the various embodiments of the present invention.

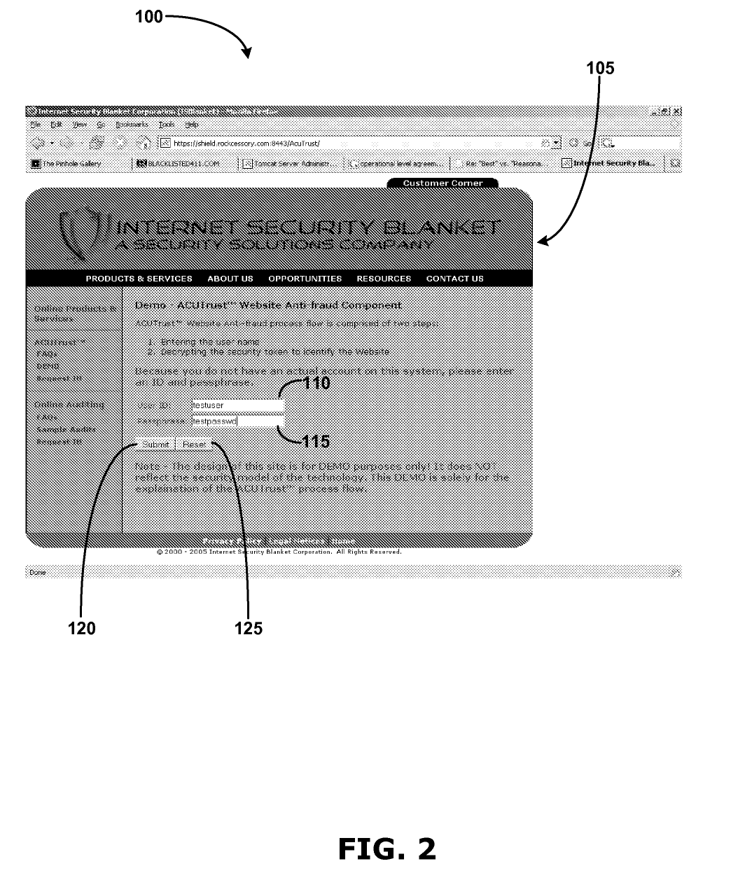

Upon activating some embodiments of the present invention, a user can receive an interface similar to the interface illustrated in FIG. 1, which asks for a user's identification (“User ID” or “login name”) in a User ID field 110. If a user has not accessed a service provider's interface 100 ever or in a predetermined time range, then a user may also provide a passphrase in a Passphrase field 115. For discussion purposes, the website 105 embodiment of the present invention discussed below will assume that a user only inputs a login name in the User Field 110 to initiate an identification authentication process according to the present invention. FIG. 2 illustrates the sample user interface 100 after a user has provided a login name in the User ID field 110 and a passphrase in the Passphrase field 115 in accordance with some embodiments of the present invention.

Once a user inputs a login name and submits the login name by pressing a submit button 120 (or activating a similar submit process), the service provider's website 105 can verify the identity of the user and using the identity of the user generate a security token. The interface 100 can also comprise a reset function, such as reset button 125, capable of clearing or resetting the interface 100 for subsequent access attempts.

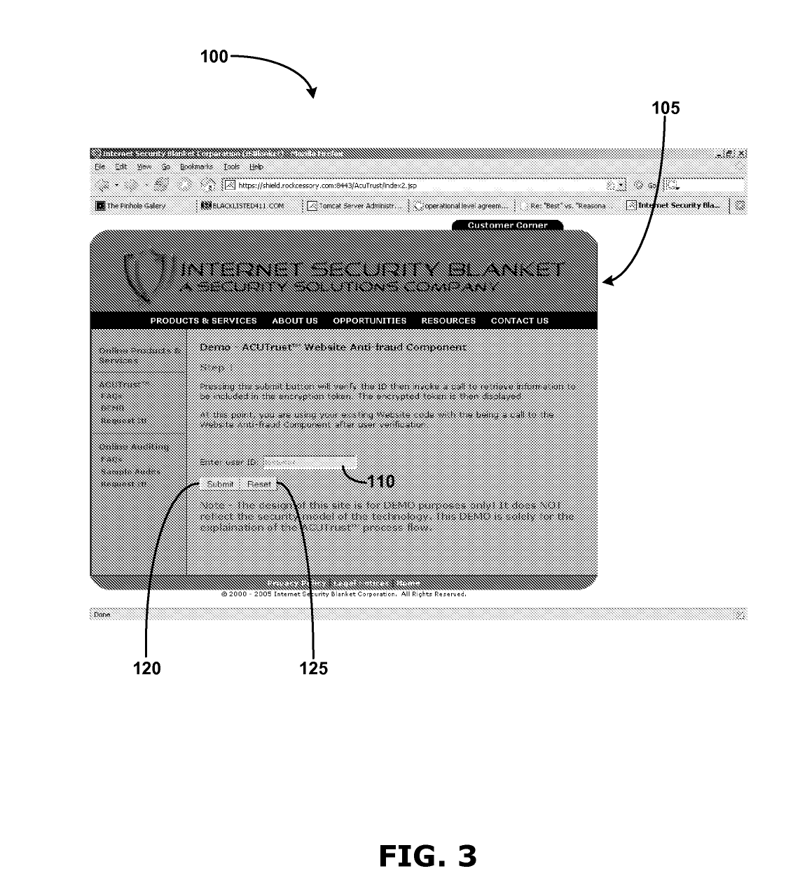

FIG. 3 illustrates the sample user interface 100 after a user submits a login name to initiate generation of a token in accordance with some embodiments of the present invention. In some embodiments, the service provider's website, upon submission of a user's login name, will query a database to determine if the submitted login name is associated with the service provider. The database is preferably located within the service provider's network, and can be located elsewhere. If the login name is associated with the service provider, then preferably the service provider's system generates a security token.

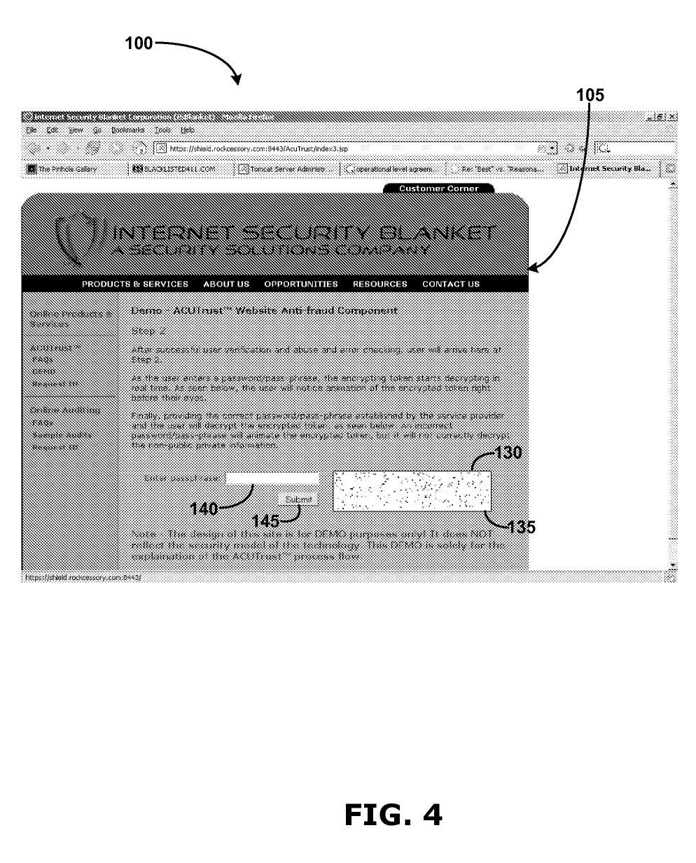

FIG. 4 illustrates the sample user interface 100 which enables display of a security token 130 in real time in accordance with some embodiments of the present invention. A token generator can generate the security token 130. The token generator can be located within the service provider's system; alternatively, the security token can be located elsewhere. The token generator preferably utilizes an encryption algorithm to generate the security token and associated encryption key for the security token. For example, the token generator can use the AES algorithm to generate a 128-bit key that is necessary to decrypt the security token. Alternatively, the token generator can also encode the security token utilizing various encoding schemes for data transmission purposes. As discussed in more detail below, encoding the security token is not a required feature of a token generator.

The security token 130 also preferably contains token information 135, which is information unique to a user. Upon first receiving the security token 130, the token information 135 is hidden from a user as shown in FIG. 4. As will be discussed below in greater detail, a HTML coded block can be used to display the hidden, encrypted token information 135. A user and the service provider may have previously agreed upon the token information 135. The token information may contain visual information, audio information, or a combination of both. Upon submission of a user's login name, the token generator can access a database and retrieve token information 135 associated with the user and generate the security token 130. Because a user knows the token information 135, the user can provide a passphrase in the Passphrase field 140 to decrypt the security token 130 and verify the token information 135 by receiving a token confirmation.

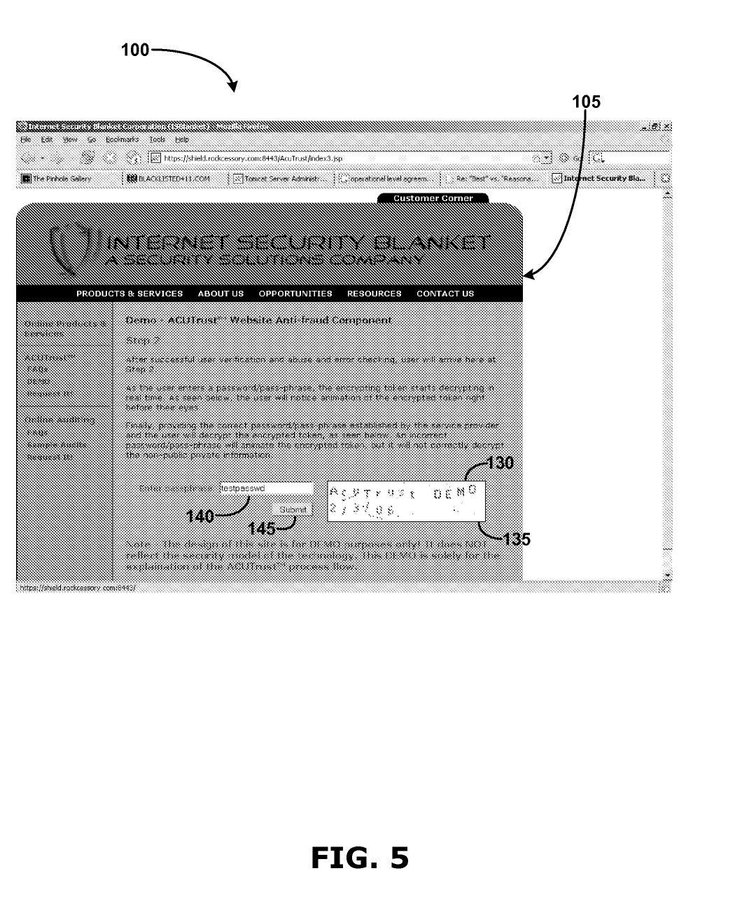

FIG. 5 illustrates the sample user interface 100 displaying a decrypted security token 130 so that a user can authenticate the website 105 in accordance with some embodiments of the present invention. As can be seen by comparing FIGS. 4 and 5, when a user provides a correct passphrase in the Passphrase field 140, the security token 130 starts decrypting in real time to reveal the token information 135. In other words, the security token 130 dynamically changes as a user enters a correct passphrase from a fully-encrypted stage to a fully-decrypted stage. Preferably, the security token 130 remains encrypted until the correct passphrase is provided so that the security token 130 is not partially decrypted.

The inventor has discovered a novel HTML coded block to enable dynamic decryption of the security token 130 and as discussed in more detail below. It should be understood that any visual or audio element could be used for dynamically decrypting the security token 130. The novel HTML coded block can be executed by a client-side processing application such as JavaScript so that pixels within the HTML animate when passphrase information is provided. And, the novel HTML coded block can dynamically animate to reveal the token information when the correct passphrase is received. Thus, providing a correct passphrase known by a user and a service provider will fully-decrypt the security token 130 as shown in FIG. 5. An incorrect passphrase can animate the security token, but preferably does not decrypt the security token 130 to reveal the token information 135.

The decryption of the security token 130 enables the user to verify and authenticate the identity of the service provider. The verification and authentication is possible because the user knows the appropriate passphrase to obtain the token information 135, and once the user decrypts the security token 130 to obtain the familiar token information 135, the user then knows that the website 105 is provided by an authentic service provider. If the user enters the correct passphrase and the security token 130 does not decrypt revealing the familiar token information 135, then the user can then determine that the service provider does not provide the website 105 and that the website 105 is a fake or unauthorized website not provided by the service provider. In other words, if this occurs, then the user has failed to verify the identity of the service provider and can then stop or cease any transaction with the fake or unauthorized website.

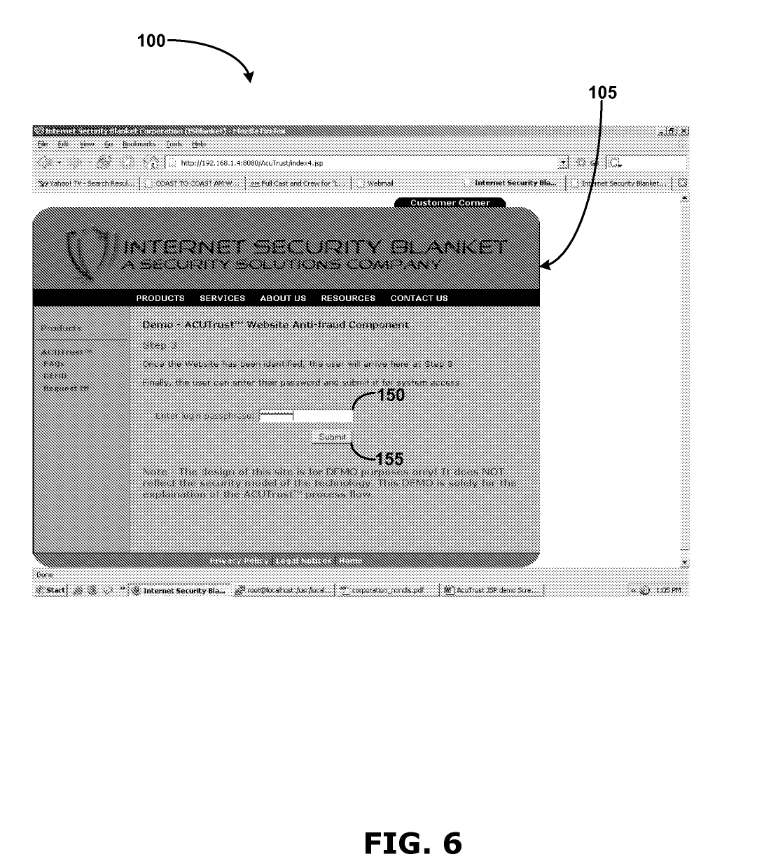

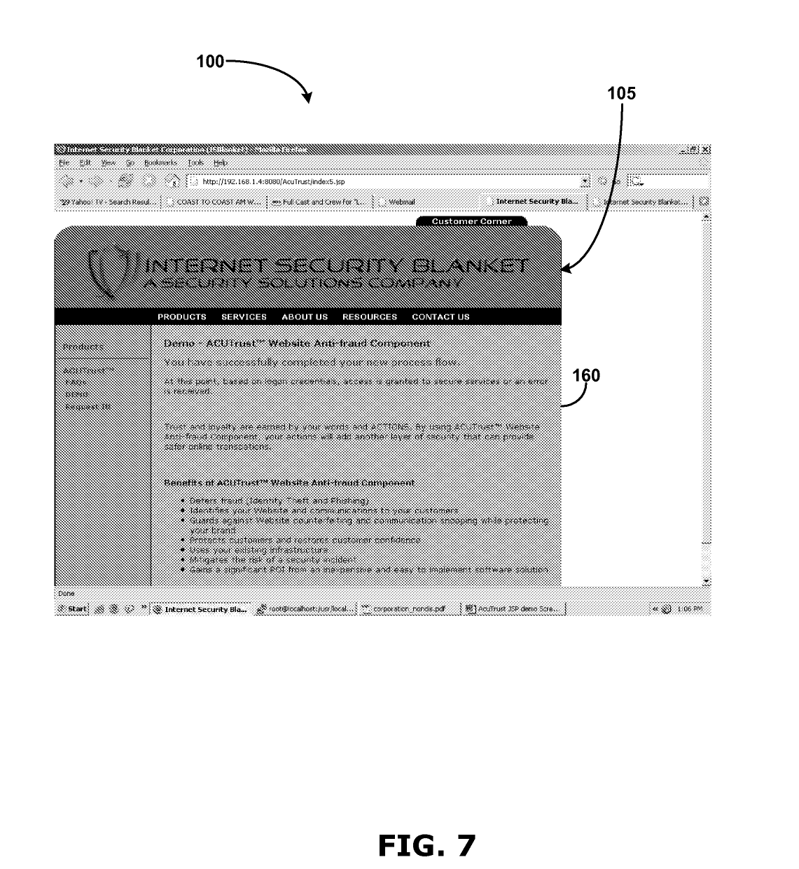

FIG. 6 illustrates the sample user interface 100 enabling a user to access the website 105 after the user has authenticated the website 105 with a security token 130 in accordance with some embodiments of the present invention. Upon successful authentication of the website 105, the user then knows that the website 105 is authentic and can then complete the login process to the website 105. By virtue of the user completing the login process to the website 105, the website can verify and authenticate the user thereby completing an authentication identification process in accordance with embodiments of the present invention. Upon completion of an authentication identification process, the sample user interface 105 may provide authentication confirmation screen 160 confirming successful identification authentication between a user and the website 105 as shown in FIG. 7.

As discussed above, the security token 130 is presented to a user during identification to enable a user to authenticate the website 105 in an active identification authentication process according to some embodiments. The security token 130 can also be provided along with a communication from a service provider to a user in a passive identification authentication process according to some embodiments. Indeed, various embodiments of the present invention utilize an encrypted token-based system to allow the authenticity of an electronic communication to be verified. A security token can be provided to a user in a format easy for a person to interpret such as a visual display, a sound, or a combination of both.

Once the identification of the intended recipient of the token is determined, either through an active or a passive method, the token generation process can be used to create the encrypted token used by the token display process. The token can then be packaged with any needed token display code, such as HTML code, and formatted for delivery to the recipient. Delivery can occur through a website or in concert with a communication from a sender. A complete packaged and formatted security token is then delivered to a recipient.

Some embodiments of the present invention can be used along with websites, HTML documents, or any digital electronic file. A security token provided in association with an HTML document can be accomplished using a client-side scripting variable. As those skilled in the art will understand, references to client-side includes computing devices used by users and consumers when transacting with service provider computing devices. The variable can be of arbitrary length, and preferably represents the encrypted data (or token information) to be displayed to a recipient. The information to be encoded into the security token is arbitrary, but should be chosen to present specific, unique and identifying information to the recipient. Examples of information that can be encoded include a time stamp, a file, a piece of user specific or identifying information, information that identifies the accessing machine, or any shared secret between a sender and a recipient.

While other embodiments are possible, the inventor has discovered that client-side processing to present a security token to a receiver enables the receiver to receive the security token in an easily recognized format. In addition, client-side processing enables dynamic decryption of a security token so that as a user provides password information, the security token is animated. The animation can include movement of visual elements. The animation preferably continues until the correct password is provided so that when the correct password is provided, the security token is decrypted to display the token information. The decrypted token can be displayed so that it is difficult for a machine to perform data interpretation on thus making the security token secure from being interpreted by a computer.

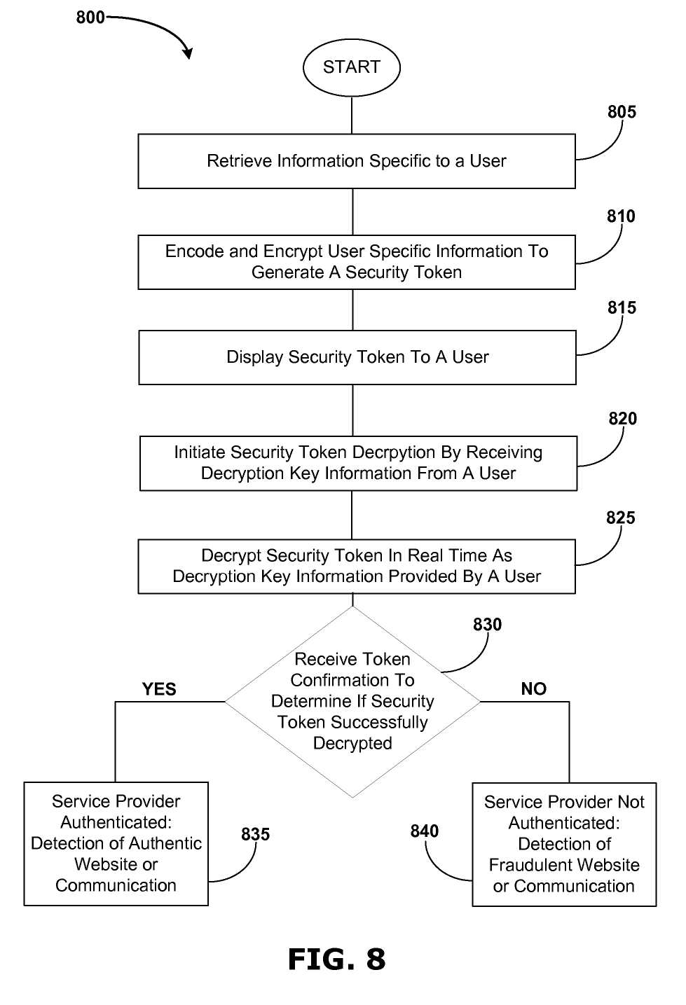

FIG. 8 illustrates a logic flow diagram showing an identification authentication method 800 according to some embodiments of the present invention. The method 800 has several steps enabling user specific information to be retrieved from a database so the user specific information can be encoded and encrypted into a security token. The method 800 is only one method according to embodiments of the present invention and can be performed in a different order than that depicted in FIG. 8. The method 800 initiates at 805 where a user's login name is used to retrieve information specific to the user. The user specific information preferably provides information that a user will recognize, thus enabling the user to verify and authenticate a service provider upon successful decryption of a security token.

Next at 810, a token generator receives the user specific information and generates a security token by encrypting the user information. The token generator may also encode the user specific information when generating the security token. Encoding can be accomplished with various encoding schemes and programming languages such as Java, C++, C#, COBOL, PERL, Visual Basic (VB), and many other programming languages known by those skilled in the art. Also, encoding can be performed to improve data transfer issues due to bandwidth and can be accomplished using. Encoding is not required to implement embodiments of the present invention, but may be used in accordance with some embodiments and those skilled in the art will be familiar with various encoding schemes.

Then at 815, the security token can be displayed to a user or recipient of a communication. The security token can be displayed using HTML code, using XML code, graphically as visual elements, via audio, using various client-side applications, Flash animation, or the like. For example, JavaScript, VBScript, or any other client-side processing tool can render the security token as a matrix of colored HTML elements corresponding to a two dimensional array of pixels that can be displayed. The client-side processing tool also preferably enables the pixel array to animate or change states during decryption when encryption key information is received from a user. Such animation enables dynamic depiction of the security token.

Some embodiments of the present invention can also utilize various additional security features for displaying the security token to a users. For example, one or more iterations of random noise can be added to randomly add noise to the security token (random pixel). The more random noise iterations performed, the more complex of a pixel image will be provided to increase security of the token. Pixel offset and color variation can also be enabled so that each pixel is vertically and horizontally randomly offset prior to display to deter token analysis. Each pixel's color can be altered prior to display to deter token analysis. Color variation and font per character may not be enabled so that each character of the token information can have own its own font type, size, and face characteristics. Other features can also be used when displaying the security token including multiple lines of display text may not be enabled so that more lines of text enables more lines of information. Custom amounts of noise (including adding line noise) may not be enabled because randomly placed diagonal, vertical, and horizontal lines can be used to deter token analysis. Further, disabling character offset and color variation may be enabled to allow many parameters of the security token to be customizable.

Also, the HTML DIV element can be used in conjunction with cascading style sheet elements to produce colored visual element of arbitrary size when displaying the security token to a user. Below is an example of a HTML DIV element pixel: <div style=‘position:absolute;top:20px;left:20px;background-color:#0000FF;width:2px;font-size=2px;’>&nbsp;</div>

The above HTML pixel is rendered in the color 0000FF and has an effective size of 2 px by 2 px. Many aspects in the above HTML code example are variable in accordance with various embodiments of the present invention. The DIV element can be any block element such as <SPAN> or <P> that allow style sheet properties to be assigned. The ‘&nbsp;’ or the text information can be any amount of information, however, some information such as log text phrases may impact the effective size of the rendered pixel when displayed.

After the security token is displayed, a user can initiate an authentication process to determine if the security token is authentic by decrypting the security token at 820. Successful decryption of the security token preferably verifies a service provider's identity. During the authenticating process, real time decoding and decryption of the security token takes place as a password (or passphrase) is provided by a user at 825. The real time decoding and decryption also enables dynamic animation of the security token as the password is being received. Decryption occurs when provided password information is received and used to decrypt the security token such that the security token animates and dynamically decrypts when the correct password is provided. Preferably, no partial decryption of the security token occurs to deter analysis of the encrypted security token.

At 830, a user can determine if the security token has been successfully decrypted and decoded to provide the token information via a token confirmation. Once the correct encryption key information (password and/or passphrase) is provided, the security token is correctly decrypted and decoded revealing the token information to the user, thus authenticating the service provider to the user at 835 via a token confirmation. If an incomplete or incorrect password (or passphrase) is provided the security token animates but is displayed or provided to the user in some unrecognizable form. Also, if the security token is not successfully decrypted when a user provides the correct password (or passphrase), then user can then determine that that service provider is not authentic at 840 and cease any further information exchange with the fraudulent service provider. The token information may be modulated in different ways as to make the data recognizable to a person but difficult for a machine to recognize.

When embodiments of the present invention are used to authenticate communications such as email, instant messages, web services, text messages, audio gram, video gram, picture gram, or other electronic document sending mechanism, only the password/pass-phrase step of authentication may be required. This is because a user's name can be presumed (i.e., the recipient of the email is the user's name). If the present invention is implemented so that a third party provides identification authentication services for a service provider (hosting solution), the third party can generate a security token can for one or more communication recipients using unique user information stored by the service provider. In this embodiment, the service provider would provide a communication, a list of recipients who will receive the communication, and unique information for each recipient. The third party can then generate a security token for each specific recipient, and then provide the communication and associated security token back to the service provider so the service provider can deliver the communication to the recipients.

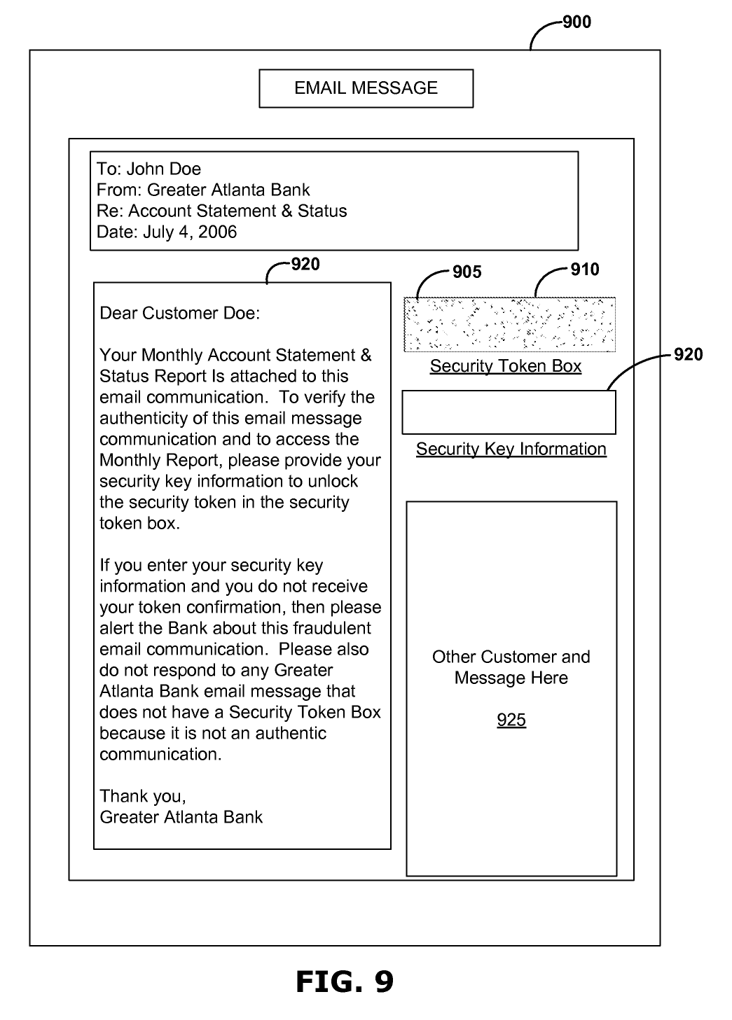

FIG. 9 illustrates a sample communication, an email message 900, enabling a recipient to verify a sender's identity in accordance with some embodiments of the present invention. In this particular email message 900 embodiment, the sender is a Bank and the recipient is a client of the Bank. Due to confidential nature of banking information, the Bank desires to send confidential information to its clients. To do so, the Bank can send the email message 900, or similar communication, to a recipient. The email message 900 preferably contains a security token box 905 having a security token 910. The security token 910 can be displayed as an array of pixels in an encrypted mode using an HTML coded email message. As discussed herein, the security token 910 is preferably generated by a security token generator and comprises unique user information that is encrypted and can be encoded. In addition, the Bank may utilize the above discussed passive identification authentication process discussed above when sending communications to its clients since the Bank already knows who will receive the email message 900.

The Bank will send the email message 900 containing the security token 905 to enable the recipient to verify the identity of the Bank and the authenticity of the email message 900. As shown in FIG. 9, the Bank can include instructions for recipients to provide their security key information in a security key information field 920 to decrypt the security token 910. As a recipient enters in their security key information in the security key information field 920, the security token preferably dynamically decrypts to reveal the recipient's personal token confirmation. Because the security token 910 is encrypted, the email message 900 and the security token 910 is safe from scammers who may intercept the email message 900. In addition, because the security token 910 contains previously agreed upon information (i.e., unique user information), the recipient will know that the email message 900 is from the Bank when the security token 910 is decrypted to reveal the unique user information via a token confirmation. Similarly, if recipients do not see their unique user information via a token confirmation, then the recipients will know that the email message 900 is not authentic.

The email message 900 may contain additional features. For example, as mentioned above, the email message 900 may contain an instruction field 915 to present messages and instructions for recipients. The email message 900 may also contain any number of other fields, such as field 925, to convey additional information about the Bank or other topics to recipients that a service provider may want to present to recipients. Also, the email message 900 may only contain an internet link to another website capable of authenticating the email message such that the security token 910 may not be sent in the email message 900. In addition, any number of communications from a service provider to a recipient may be sent in a similar fashion as the email message 900.

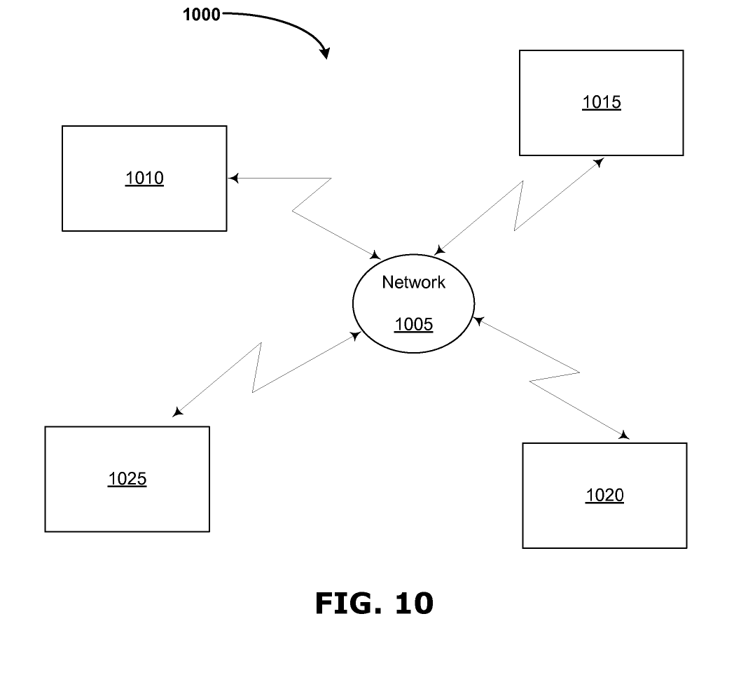

FIG. 10 illustrates a computer network system 1000 utilizing an embodiment of the present invention to provide identification authentication for users. Those skilled in the art will understand the present invention can be implemented on any computer network 1005, public or private. The computer network 1005 can include multiple computing devices 1010, 1015, 1020, 1025 (computers, file servers, web servers, laptop computer, personal digital assistants, or any other electronic device capable of accessing a network) having wired or wireless connections to the network 1005. Indeed, some implementations may be utilized so that a user attempting to access the network 1005 with an electronic device (1010-1025) can authenticate the identity of the network 1005 before exchanging information over the network. For example, in a network authentication embodiment, a wireless laptop user can verify the identity of a network to ensure a secure connection to the network.

As mentioned above, embodiments of the present invention may be implemented as computer software on one or more conventional computer devices. A conventional computer device 1010 is shown in FIG. 10. The conventional computer device 1010 can comprise a processor, a memory, and various input/output interface devices. The processor can retrieve and execute software instructions stored in the memory, which may be volatile or non volatile, and the processor may control other components to perform the present invention. The memory may be used to store program instructions, data, or both. The input devices can include a computer keyboard, mouse, or both enables user input to the device 1010. The output devices can include a display, a printer, or audio system enabling the device 1010 to provide information such as instructions, data, or other information to a user. The memory can store a computer program product that has encoded thereon computer readable program code devices, such as magnetic charges or optical encodings which can be encoded as program instructions, data or both to configure the computer device 1010. For example, the token generator feature of the present invention can be a program module stored in memory so that the token generator can be processed to access other stored information and to encode and encrypt information to provide a security token.

Also, the computer network system 1000 can be adapted for the various implementation embodiments of the present invention. In a first example, a service provider may utilize the computer device 1010 as a web-host server enabling consumers or requesters to access the computer device 1010 via the Internet. The computer device 1010 can be configured to include a database for storing unique user information and configured to comprise a token generator. If a user utilizing a second computing device 1025 desires to access computing device 1010 through network 1005, the user can utilize some embodiments of the present invention to authenticate computing device 1010. For example, when accessing computing device 1010 with the second computing device 1025, the user can receive a security token from the computing device 1010 through a web browser and decrypt the security token in real time to authenticate and verify the identity of the computing device 1010. After the user verifies the identity of the computing device 1010, the user can then feel secure in exchanging information over network 1005 with the computing device 1010.

In yet another network embodiment, the present invention may be implemented as a combination of software and hardware. This embodiment may provide a hosted solution for service providers that desire to implement an embodiment of the present invention. For example, a service provider may ask a third party, such as Internet Security Blanket Corporation, to host an identification authentication service for the service provider. In this implementation, the service provider may direct its consumers to an internet site hosted by the third party and the third party can enable the consumers to authenticate the service provider. This implementation can utilize one or more computing devices such that the service provider, the consumers, and the third party service provider can be networked together when enabling identification authentication.

While the various embodiments of this invention have been described in detail with particular reference to exemplary embodiments, those skilled in the art will understand that variations and modifications can be effected within the scope of the various embodiments of invention as defined in the appended claims. Accordingly, the scope of the various embodiments of the present invention should not be limited to the above discussed embodiments, and should only be defined by the following claims and all equivalents.

I claim:

1. An identification authentication system comprising:
a first device networked to a second device so that the first device can communicate with the second device, the first device being adapted to receive a first set of user information and communicate the first set of user information to the second device;
the second device being adapted to generate a security token in response to the first set of user information and provide the security token to the first device for user review, the security token comprising token information; and
the first device being adapted to receive a second set of user information so that a user can dynamically decrypt the security token in substantially real time to access the token information to authenticate the second device.

2. The system of claim 1, the second device comprising a token generator to generate the security token, wherein the token generator generates the security token based on the first set of user information.

3. The system of claim 2, wherein the token generator receives unique user information from a database based upon the first set of user information, and wherein the token generator encrypts the unique user information and provides the encrypted unique user information as at least part of the security token.

4. The system of claim 3, wherein the token generator utilizes a symmetric encryption algorithm to encrypt the unique user information.

5. The system of claim 3, further comprising a third device in communication with the second device, the third device being adapted to provide the token generator with the unique user information such that the unique user information is associated with the first set of user information.

6. The system of claim 1, wherein the security token comprises at least one of a visual component and an audio component.

7. The system of claim 1, wherein the security token comprises hypertext markup language (HTML) code that upon receipt of at least a portion of the second set of user information is adapted to animate the security token and dynamically reveal the token information.

8. The system of claim 1, wherein the decrypted token information is formatted so that a machine can not read the decrypted token information.

9. The system of claim 1, wherein the security token comprises a plurality of pixel elements and the first device is adapted to dynamically adjust one or more pixels of the security token upon receiving the second set of user information.

10. An identification authentication method comprising:
generating an encrypted token comprising user information;
receiving information from a user to access the user information from the encrypted token; and
using the received information to decrypt the encrypted token in substantially real time so that a user can authenticate an identity associated with a communication.

11. The method of claim 10, further comprising presenting the token to a user so that a user receives the encrypted token prior to using the received information to decrypt the encrypted token.

12. The method of claim 10, wherein generating the token comprises encrypting unique user information with a symmetric encryption algorithm.

13. The method of claim 10, wherein the communication includes at least one of an electronic mail message, a video mail message, a website file, a network device query, a network query, a text message, and a digital file.

14. The method of claim 10, wherein the received information only decrypts the encrypted token if the received information matches a previously determined encryption key such that the encrypted token is not partially decrypted.

15. The method of claim 10, further comprising displaying the encrypted token as a block of HTML code.

16. The method of claim 15, wherein the HTML code block has a plurality of pixel elements adapted to dynamically change to reveal the token information when the security token is decrypted.

17. An authentication method between a user and a service provider comprising:
generating a security token based at least partially on user information, the security token comprising encrypted token information;
presenting the security token to a user;
decrypting the security token in substantially real time so that during decryption the token information is dynamically presented to a user so that a user utilizes the decrypted security token to authenticate a service provider; and
receiving information from a user so that a service provider can authenticate the user.

18. The method of claim 17, wherein generating the security token comprises encrypting the security token with a symmetric encryption algorithm.

19. The method of claim 18, wherein presenting the security token comprises displaying the security token in at least one of a visual format and an audio format.

20. The method of claim 19, wherein decrypting the security token in substantially real time comprises utilizing information provided by a user to animate the security token so that the encrypted token information is dynamically decrypted.
